(19) United States
(12) Patent Application Publication
(10) Pub. No.: US 2007/0050621 A1
(43) Pub. Date: Mar. 1, 2007

(54) Method for prohibiting an unauthorized component from functioning with a host device

(76) Inventors: Kevin Young, Granite Bay, CA (US); Richard Parker, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/216,240

(22) Filed: Aug. 30, 2005

(51) Int. Cl. H04L 9/00

(52) U.S. Cl. 713/168

(57) ABSTRACT

A method for prohibiting an unauthorized component from functioning with a host device is disclosed. The method includes reading key information from a component and inputting the key information into an algorithm to generate a first identifier. In addition, the method includes detecting a coupling between the component and a host device running the algorithm to generate a second identifier. Further, the method includes comparing the first identifier to the second identifier, and if the first identifier matches with the second identifier, then the component will be allowed to function with the host device; and if the first identifier does not match with the second identifier, then the component will be prohibited from functioning with the host device.

### TECHNOLOGY

The present invention relates to a method and an apparatus for prohibiting an unauthorized component from functioning with a host device.

### BACKGROUND

For a variety of reasons, host device manufacturers have designed host devices that function with a variety of plug and play components. For end users, one advantage of this design is that it offers flexibility and ease of upgrades. For example, instead of purchasing a newer host device, it may be more cost-effective for end users to increase the performance of the host device by buying a component and inserting the component into a pre-existing host device. The component can enable the host device to perform enhanced functions or confer added capabilities. In addition, because components can be easily removed and replaced, repair efforts may be reduced. Another advantage is that a single host device design can support many different applications. Accordingly, end users can tailor the host device to his or her particular needs by simply purchasing and installing the appropriate components or modules into the host device.

Furthermore, for host device manufacturers, the sale of components creates another source of revenue. This source of revenue is important to host device manufacturers because it can be applied towards further research and development efforts. Ultimately, the additional research and development results in delivering superior technologies of higher quality to end users. Thus, a mutually beneficial relationship is forged between host device manufacturers and end users.

Unfortunately, due to the significance of the host device market, third-party vendors have been undercutting host device manufacturers by offering end users with unauthorized but compatible components. Moreover, traditionally, these third-party vendors do not expend comparable funds for research and development but instead take advantage of host device manufacturers' research and development efforts.

Because third-party vendors have neither invested effort into research and development nor possess first-hand knowledge of how host devices function, one concern is that unauthorized but superficially compatible components manufactured by third-party vendors may be of inferior quality. For example, a component may be superficially compatible but deliver inferior results because of a minor difference in design. Also, an unauthorized component may not have gone through rigorous testing. As a result, an unauthorized component may be less reliable and possess hidden defects. Consequently, an unauthorized component may malfunction and cause the performance of a host device to degrade. Moreover, an unauthorized component may even cause a host device itself to malfunction. A malfunctioning in either a host device or a component will cause a severe decrease in efficiency. Consequently, these problems will generate end user frustration and dissatisfaction. Hence, it would be beneficial for both host device manufacturers and end users if the use of unauthorized components can be discouraged.

### SUMMARY

A method for prohibiting an unauthorized component from functioning with a host device is disclosed. The method includes reading key information from a component and inputting the key information into an algorithm to generate a first identifier. Upon detecting that a component is inserted into a host device, the first identifier and key information are read from the component. Next, the algorithm runs to generate a second identifier. Thereupon, the first identifier is compared to the second identifier, and if the first identifier matches with the second identifier, then the component will be allowed to function with the host device. However, if the first identifier does not match with the second identifier, then the component will be prohibited from functioning with the host device. Thereby, unauthorized components are prohibited from functioning with the host device.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1 illustrates a flow chart showing a method for prohibiting an unauthorized component from functioning with a host device.

FIG. 2 illustrates a processor running an algorithm coupled to a host device interface.

FIG. 3 illustrates a specific embodiment of the present invention wherein the component is a transceiver and the host device is a switch.

FIG. 4 illustrates a specific embodiment of the present invention wherein the component has built-in memory.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

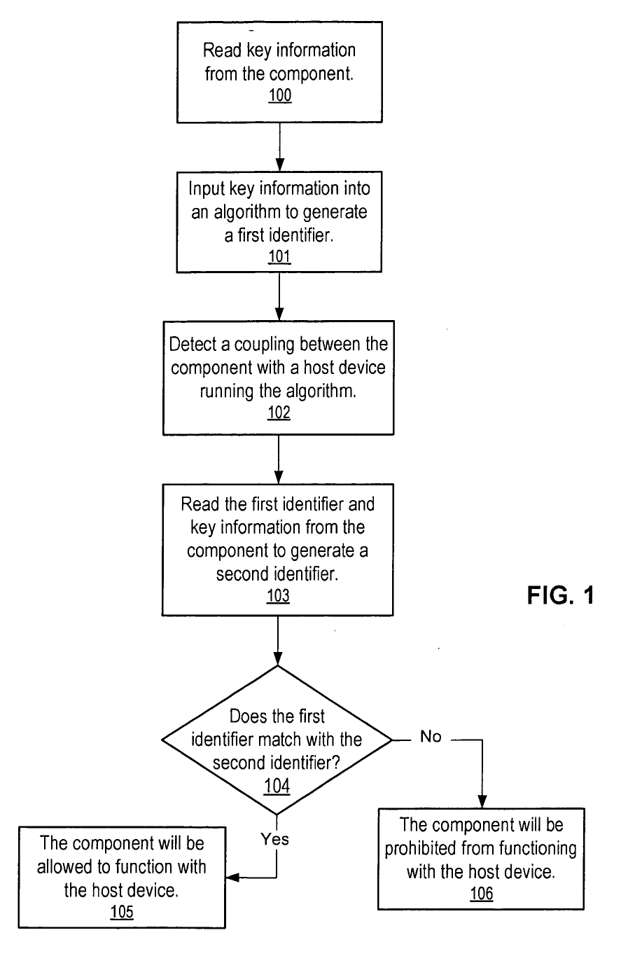

FIG. 1 illustrates a flow chart showing a method for prohibiting an unauthorized component from functioning with a host device. At block 100, key information is read from the component. At block 101, key information is inputted into an algorithm to generate a first identifier. At block 102, a coupling between the component and the host device running the algorithm is detected. At block 103, the first identifier and key information is read from the component to generate a second identifier. At block 104, the first identifier will be compared with the second identifier. In block 105, if the first identifier matches with the second identifier, the component will be allowed to function with the host device. At block 106, if the first identifier does not match with the second identifier, the component will be prohibited from functioning with the host device.

In one embodiment, the component is a transceiver and the host device is a switch. In other embodiments, the host device can be a printer, copier, fax machine, camera, scanner, television, monitor, projector, personal digital assistant, audio recording device, or a mobile audio device. In still more embodiments, the component can be a printer cartridge, a copier cartridge, a fax machine cartridge, a duplexer, a scanner tray, a receiver, a memory, an adaptor, a network card, or a wireless connection device.

While the invention is described in conjunction with the above embodiment, it will be understood that they are not intended to limit the invention to these embodiments. On the contrary, the invention is intended to cover alternatives, modification and equivalents, which may be included within the spirit and scope of the invention as defined by the appended claims.

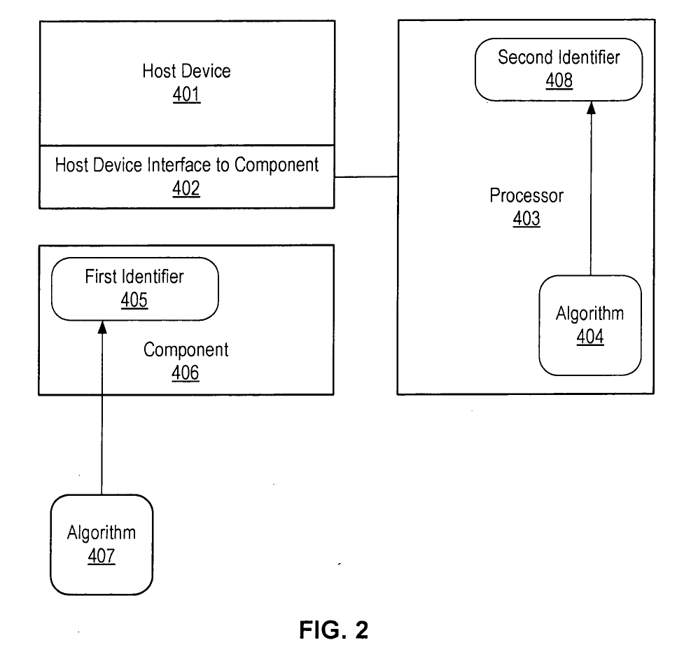

FIG. 2 illustrates a processor running an algorithm coupled to a host device interface. The host device 401 has a host device interface to component 402 for coupling with component 406. Component 406 has a first identifier 405 generated by algorithm 407. When component 406 is coupled with host device 401 via host device interface to component 402, the processor 403 running an algorithm 404 will generate a second identifier 408. Next, the first identifier 405 is compared to the second identifier 408, and if the first identifier 405 matches with the second identifier 408, then the component 406 will be allowed to function with the host device 401. However, if the first identifier 405 does not match with the second identifier 408, then the component 406 will be prohibited from functioning with the host device 401.

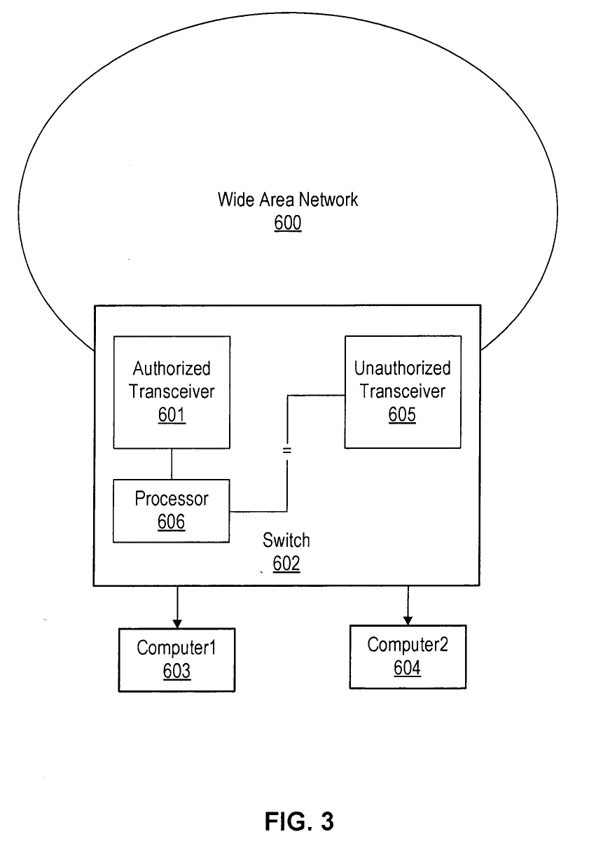

FIG. 3 illustrates a specific embodiment of the present invention wherein the component is a transceiver and the host device is a switch. The transceiver 601 is coupled to the switch 602. Switch 602 is coupled to the Wide Area Network 600 and serves as router to direct network packets. For instance, the switch 602 may direct network packets to either computer 603 or computer 604. In one example, an authorized transceiver 601 is inserted into the host device switch 602. The processor 606 running an algorithm will generate a second identifier and compare it with the first identifier stored on authorized transceiver 601. If the first identifier matches with the second identifier, then transceiver 601 will be allowed to function with the switch 602. In another example, an unauthorized transceiver 605 is inserted into the host device switch 602. The processor 606 running an algorithm will generate a second identifier and compare it with the first identifier stored on unauthorized transceiver 605. If the first identifier does not match with the second identifier, then the unauthorized transceiver 605 will be prohibited from functioning with the switch 602.

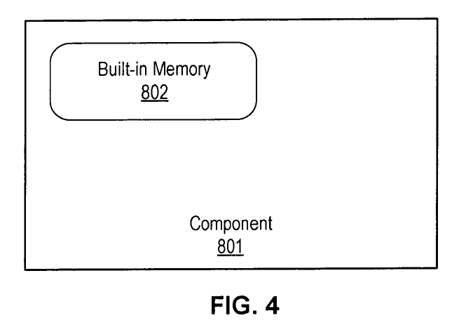

FIG. 4 illustrates a specific embodiment of the present invention wherein the component has built-in memory. The component 801 has built-in memory 802. In one example, key information is read from built-in memory 802 on component 801 and fed into an algorithm to generate a first identifier. In another example, the first identifier generated by an algorithm can be saved onto built-in memory 802. In yet another example, a processor coupled to a host device running an algorithm can access the first identifier saved on built-in memory 802; the first identifier can thereupon be compared with a second identifier.

In conclusion, a unique and novel way to prohibit an unauthorized component from functioning with a host device is disclosed. This is beneficial because unauthorized components may be of inferior quality. One reason is that third-party vendors have neither invested effort into research and development nor possess first-hand knowledge of how the host device functions. For example, a component may be superficially compatible but deliver inferior results because of a minor difference in design. Also, an unauthorized component may not have gone through rigorous testing. As a result, an unauthorized component may be less reliable and possess hidden defects. Consequently, an unauthorized component may malfunction and cause the performance of the host device to degrade. Moreover, an unauthorized component may even cause the host device itself to malfunction. A malfunctioning in either the host device or the component will cause a severe decrease in efficiency. Consequently, these problems will generate end user frustration and dissatisfaction. Thus, it would be beneficial for both host device manufacturers and end users if the use of unauthorized components is discouraged. Hence, the present invention allows the use of unauthorized components to be discouraged and consequently improves overall performance by encouraging the use of authorized and more reliable components.

What is claimed is:

1. A method for prohibiting an unauthorized component from functioning with a host device, comprising:
reading key information from a component and inputting said key information into an algorithm to generate a first identifier;
detecting a coupling between said component with a host device running said algorithm;
reading said first identifier and said key information from said component;
generating a second identifier;
comparing said first identifier to said second identifier, wherein if said first identifier matches with said second identifier, then said component will be allowed to function with said host device; and if said first identifier does not match with said second identifier, then said component will be prohibited from functioning with said host device.

2. The method as recited in claim 1, wherein said component comprises a transceiver.

3. The method as recited in claim 1, wherein said host device comprises a switch.

4. The method as recited in claim 1, wherein said host device comprises a printer.

5. The method as recited in claim 1, wherein said host device comprises a copier.

6. The method as recited in claim 1, wherein said host device comprises a fax.

7. The method as recited in claim 1, wherein said host device comprises a scanner.

8. The method as recited in claim 1, wherein said host device comprises a personal digital assistant.

9. The method as recited in claim 1, wherein said reading comprises accessing a built-in memory of said component.

10. The method as recited in claim 1, wherein said saving comprises storing said key information onto said component's built-in memory.

11. A host device that performs a set of functions comprising:
an interface adapted to accept a component, wherein said component includes a first identifier generated by an algorithm and wherein said algorithm reads information stored on said component;
a processor coupled to said interface, wherein said processor running said algorithm generates a second identifier and compares said first identifier to said second identifier, wherein if said first identifier matches with said second identifier, then said component will be allowed to function with said host device and if said first identifier does not match with said second identifier, then said component will be prohibited from functioning with said device.

12. The host device as recited in claim 11, wherein the said component comprises a transceiver.

13. The host device as recited in claim 11, wherein the said host device comprises a switch.

14. The host device as recited in claim 11, wherein said reading comprises accessing said component's built-in memory.

15. The host device as recited in claim 11, wherein said saving comprises storing said key information onto a built-in memory corresponding to said component.

16. A component adapted to interface with a host device comprising:
a memory for storing a first identifier generated by an algorithm, wherein said algorithm reads information stored on said component;
an interface adapted to couple with said host device, wherein said host device includes a processor coupled to said interface, wherein said processor running said algorithm generates a second identifier and compares said first identifier to said second identifier, wherein if said first identifier matches with said second identifier, then said component will be allowed to function with said host device and if said first identifier does not match with said second identifier, then said component will be prohibited from functioning with said device.

17. The component as recited in claim 16, wherein the said component comprises a transceiver.

18. The component as recited in claim 16, wherein the said host device comprises a switch.

19. The component as recited in claim 16, wherein said reading comprises accessing said component's built-in memory.

20. The component as recited in claim 16, wherein said saving comprises storing said key information onto said component's built-in memory.
